(19) United States
(12) Patent Application Publication
(10) Pub. No.: US 2008/0151426 A1
(43) Pub. Date: Jun. 26, 2008

(54) System and method for compliant, adaptive hard drive sliders

(76) Inventors: Fu-Ying Huang, San Jose, CA (US); Timothy C. Reiley, San Jose, CA (US); Timothy C. Strand, San Jose, CA (US); Qinghua Zeng, Fremont, CA (US)

Correspondence Address: HITACHI C/O WAGNER BLECHER LLP, 123 WESTRIDGE DRIVE, WATSONVILLE, CA, 95076, US

(21) Appl. No.: 11/643,055

(22) Filed: Dec. 20, 2006

(51) Int. Cl. G11B 5/60

(52) U.S. Cl. 360/234.3

(57) ABSTRACT

A system and method for dynamically controlling the position of a hard drive head is disclosed. The system includes a hard drive slider comprising a first substrate, a second substrate coupled to the first substrate wherein the second substrate comprises a plurality of flexures wherein at least one of the flexures is responsive to an applied current, the flexure expanding in response to the current; and a third substrate coupled to the second substrate comprising vias to provide said current to the flexure. Embodiments of the invention can be used in contact and non contact recording situations and for absorbing mechanical vibrations.

### FIELD OF THE INVENTION

The present invention relates to a hard drives and more particularly to hard drive sliders.

### BACKGROUND OF THE INVENTION

Disk drives are information storage devices that utilize at least one rotatable disk with concentric data tracks containing the information, a head or transducer for reading data from or writing data to the various tracks, and a head positioning actuator connected to the head for moving it to the desired track and maintaining it over the track during read and write operations. The head is attached to a slider, such as an air-bearing slider, which is supported adjacent to the data surface of the disk by a cushion of air generated by the rotating disk. The head can also be attached to a contact recording type slider. In either case, the slider is connected to a support arm of the transducer-positioning actuator by means of a suspension.

As disk drives have become smaller in size, the recorded track density has increased dramatically. This has necessitated the use of smaller and smaller heads and sliders. However, these smaller geometries of the suspension, slider and head make manufacture much more difficult. Under current slider creation techniques, the slider is created from a monolithic body. As a result, the heads can not be built separately and placed on a slider because the level of precision required makes it too difficult for reliable placement. Current processes involve building the head up on the slider and then lapping it back until the coil is reached. One consequence of this lapping is that it has been necessary to make the head an integral part of the slider; i.e., the head is mechanically, rigidly connected to the slider.

The suspension must meet several requirements. The suspension must be flexible to provide a bias force in the vertical direction. This is necessary to provide a compensating force to the lifting force of the air bearing in order to keep the slider at the correct height above the disk. Also, vertical flexibility is needed to allow the slider to be loaded and unloaded away from the disk. Another requirement of the suspension is that it must provide a pivotal connection for the slider. Irregularities in operation may result in misalignment of the slider.

The suspension at the same time must also be rigid in both lateral and vertical direction. Rigidity in the lateral direction prevents the head from moving side to side, which would result in the head reading the wrong track. Rigidity in the vertical direction is required to maintain slider position during shock events. Shock events occur in one of two ways: 1) an asperity in the disk causes a shock when the slider impacts the asperity or 2) an external shock to the hard drive causes the slider to impact the disk. In both situations, the impact of the slider into the media can cause damage to the media as well as the hard drive head. When an impact occurs between the slider and the disk, vibrations can result in the head bouncing around during which is not possible for the head to be reading or writing.

Often times, as a result of the suspension rigidity when the head is pushed down toward the disk the suspension lifts up in response. The overall effect of this pushing down is that the suspension lifts up resulting in a loss of the benefit of pushing the head down, thus the head is not moved any closer to the disk.

### SUMMARY OF THE INVENTION

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Embodiments of the present invention include a system and method for dynamically controlling the position of a hard drive head. The system includes a hard drive slider comprising a primary slider body connected by compliant flexures to a smaller, secondary part of the slider which contains the magnetic reading sensor and writer. One variation of this structure allows current to be passed through one or more flexures, thereby causing flexure expansion and relative motion of the secondary part of the slider with respect to the primary. Embodiments of the invention can be used in contact and non-contact recording situations and for dampening mechanical vibrations.

### BRIEF DESCRIPTION OF THE DRAWINGS

The above and other objects and advantages of the present invention will be more readily appreciated from the following detailed description when read in conjunction with the accompanying drawings, wherein:

FIG. 1 is a side view of an exemplary disk drive system and a controller unit in block form in accordance with embodiments of the present invention.

FIG. 2 is a top view of an exemplary disk drive system in accordance with embodiments of the present invention.

FIG. 3A is a sideview of an exemplary hard drive slider in accordance with embodiments of the present invention.

FIGS. 3B are top views of an exemplary hard drive slider in accordance with embodiments of the present invention.

FIG. 3D is a sideview of an exemplary hard drive slider in accordance with embodiments of the present invention.

FIG. 3E is a topview of an exemplary hard drive slider in accordance with embodiments of the present invention.

FIG. 4A is a bottom view of an exemplary hard drive slider in accordance with embodiments of the present invention.

FIG. 4B is a side view of an exemplary hard drive slider in accordance with embodiments of the present invention.

FIG. 5 is a flowchart of an exemplary method for forming a hard drive slider in accordance with embodiments of the present invention.

FIG. 6 is a flowchart of an exemplary method for forming a hard drive slider in accordance with embodiments of the present invention.

### DETAILED DESCRIPTION

Reference will now be made in detail to embodiments of the present invention, a system and method for connecting an air bearing slider to its magnetic head using complaint flexures, these flexures may be used to dynamically control the position of the magnetic head, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Generally speaking, one embodiment of the invention is a slider that is flexible such that it can better respond to shock events reducing damage to head and media. The slider may be formed with 2 substrates or 3 substrates. In one embodiment, the slider consists of two substrates wherein the first substrate flexibly couples the head portion or secondary body of the slider to the primary body of the slider via flexures. The flexibility of the flexures allows the primary slider body to fly higher and more stably than the secondary slider body of the slider which is closer to the disk. This flexibility allows the slider to respond better to shock events because the flexures can deform and thus reduce the impact of the head and the disk. Also, the compliance of the flexures minimizes the effect of head/disk contact on the stability of the primary slider. Another embodiment of the invention is a slider which dynamically controls the position of the hard drive head. The slider may be made of two substrates, the first of which is etched to form flexures. These flexures can be heated by current relative to the rest of the slider and thus expand which allows control of the position of the head. The slider can also consist of three layered substrates wherein the middle or second substrate is etched and eventually further etched to create flexures. These flexures can be heated by current flowing through the flexures. This heating of one or more flexures causes an expansion which results in the movement of the hard drive head attached to the primary slider. Thus, controlling the current allows dynamic control of the position of the hard drive head. These and further embodiments of the present invention will now be discussed in further detail.

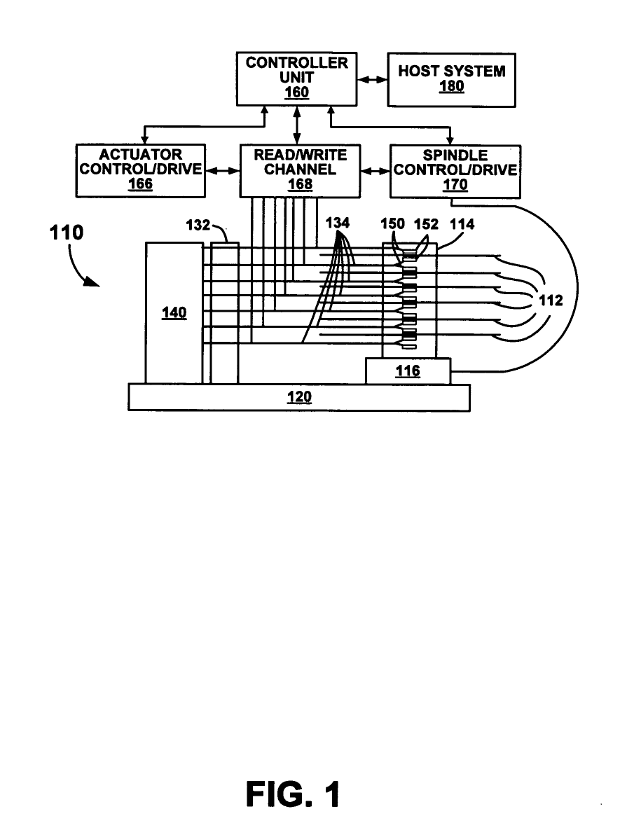

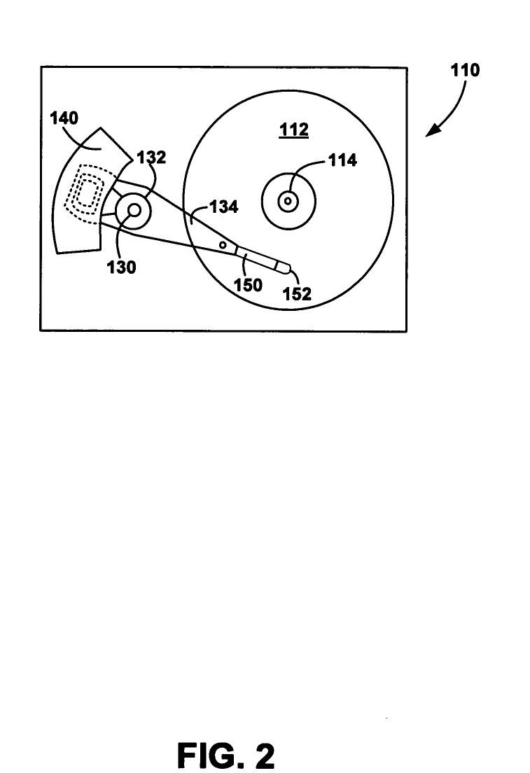

FIGS. 1 and 2 show a side and a top view, respectively, of a disk drive system designated by the general reference number 110. The disk drive system 110 comprises a plurality of stacked magnetic recording disks 112 mounted to a spindle 114. The disks 112 may be conventional thin film recording disks or, in other magnetically layered disks. The spindle 114 is attached to a spindle motor 116, which rotates the spindle 114 and disks 112. A chassis 120 provides a housing for the disk drive system 110. The spindle motor 116 and an actuator shaft 130 are attached to the chassis 120. A hub assembly 132 rotates about the actuator shaft 130 and supports a plurality of actuator arms 134. A rotary voice coil motor 140 is attached to chassis 120 and to a rear portion of the actuator arms 134.

A plurality of suspension assemblies 150 are attached to the actuator arms 134. A plurality of heads or transducers on sliders 152 are attached respectively to the suspension assemblies 150. The sliders 152 are located proximate to the disks 112 so that, during operation, the heads or transducers are in electromagnetic communication with the disks 112 for reading and writing. The rotary voice coil motor 140 rotates actuator arms 134 about the actuator shaft 130 in order to move the suspension assemblies 150 to the desired radial position on disks 112. The shaft 130, hub 132, arms 134, and motor 140 may be referred to collectively as a rotary actuator assembly.

A controller unit 160 provides overall control to system 110. Controller unit 160 typically includes (not shown) a central processing unit (CPU), a memory unit and other digital circuitry, although it should be apparent that one skilled in the computer arts could also enable these aspects as hardware logic. Controller unit 160 is connected to an actuator control/drive unit 166 that in turn is connected to the rotary voice coil motor 140. This configuration allows controller 160 to control rotation of the disks 112. A host system 180, typically a computer system, is connected to the controller unit 160. The host system 180 may send digital data to the controller 160 to be stored on disks 112, or it may request that digital data at a specified location be read from the disks 112 and sent to the system 180. The basic operation of DASD units is well known in the art and is described in more detail in The Magnetic Recording Handbook, C. Dennis Mee and Eric D. Daniel, McGraw-Hill Book Company, 1990.

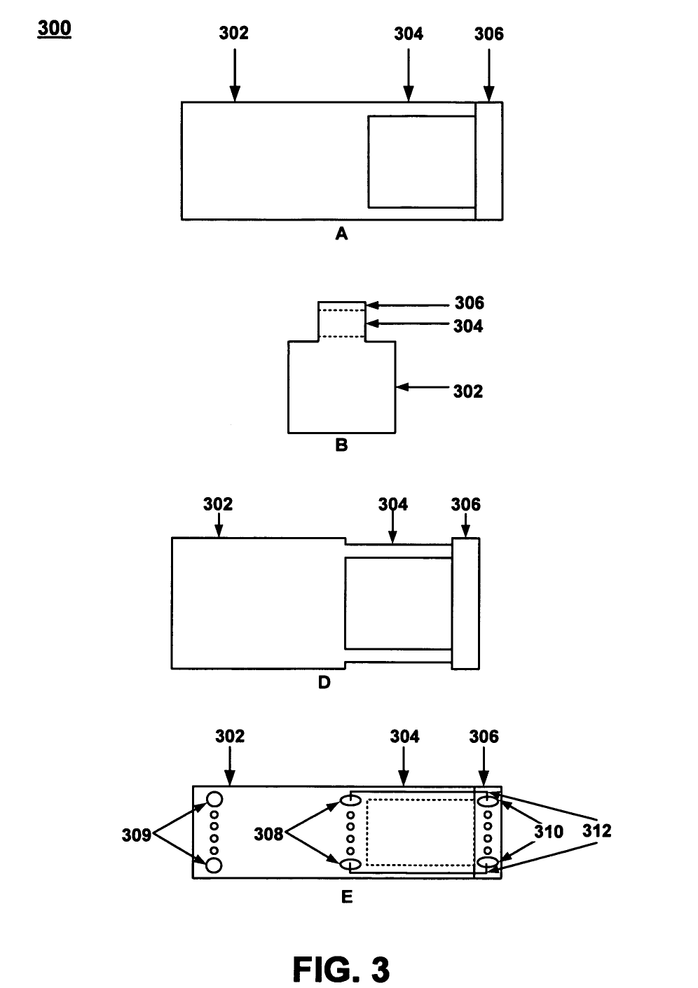

FIG. 3 is an illustration of exemplary hard drive sliders 300 in accordance with embodiments of the present invention. FIG. 3A illustrates a side view of an exemplary hard drive slider including a first substrate 302, flexures 304 and a second substrate 306. In one embodiment of the invention, the hard drive slider may be used in a data recording disk drive.

A portion of the first substrate 302 is etched or machined to create pits or trenches which later form flexures 304. First substrate 302 is then bonded to the second substrate 306. The second substrate 306 is then ground, lapped, polished to a final thickness. After the bonding of second substrate 306, the pits or trenches of the first substrate 302 are completely enclosed throughout the entire slider processing. In the last step, when the individual sliders are formed, by etching, this etch step forms the flexures. The air bearing system and read and write heads are made using conventional processes just prior to the etching. These flexures 304 may allow movement in the vertical and lateral direction. The compliance in both directions can be changed through geometric changes in the flexure cross section. The flexures 304 also reduce the effective mass and therefore the inertia of head 306. The reduced inertia lessens the severity of impacts caused by shock events and asperities in the disk, and reduces the effect of head/disk contact on the flying of the primary slider.

In one embodiment of the invention, the flexures 304 will have the same thickness and be symmetrical. The thickness of the flexures 304 and other dimensions of the slider will largely be chosen based on the material used to achieve the desired compliance. For example, in one embodiment of the invention silicon is used as a base for the substrates.

The flexures 304 further provide flexibility to the trailing edge formed by second substrate 306 of the slider to respond in the vertical direction to asperities in the disk and operational shocks when the head is over data regions of the disk. Thus, the slider can respond to shock or contact events in much better manner than conventional sliders which would have a rigid impact with the disk. This flexibility in the slider 300 may be known as compliance.

The flexibility further reduces the friction should there be contact with the disk because the slider 300 will begin to deform as secondary body of the slider pushes against the air bearing. The fact that movement can be designed to be mainly in the vertical direction means that the frictional forces can not couple and thereby excite the first mode of the compliant slider. The slider 300 is constructed such that the trailing edge of slider 300 will have resonance modes only at high frequencies beyond ABS fundamental modes and not likely to be excited by asperities in the disk or operational shocks.

In one embodiment of the invention, the slider will have a pitch or position such that the primary body of the slider will fly stably higher above the disk than the trailing edge formed by second substrate 306 and contains the head which is connected to the primary body of the slider 300 by flexures 304. This flying configuration results in the primary body of the slider encountering only large asperities in the disk and requiring the slider 300 to travel farther to come in contact with the disk when there is an operational shock. The trailing edge has a portion of the Air Bearing System (herein ABS) such that the relatively smaller mass of the trailing edge can respond quicker and more easily to any asperities or operational shocks that occur as the air bearing pushes against the primary body 306 of the slider 300 as it approaches the disk.

FIG. 3B is a further illustration of an exemplary hard drive slider 300 in accordance with embodiments of the present invention. The above processes are used to make sliders and then a portion of the sides of the end where the head is going to be is removed during one of the late etch steps. As shown in FIG. 3B, the removal may be such that the portions removed form corners with the primary body of the slider 300. The forming of the flexures connected to the secondary part of the slider which contains the head is done during the etching of the first substrate 302. In yet another embodiment, portions of the primary body 302 of the slider 300 may also be etched away after the processes used to form the air bearing. These removals of portions of the slider 300 reduce the effective mass of the secondary part of the slider and further ensure that the head and sides of the slider will not impact the disk in the case of a roll of the slider laterally.

FIG. 3D further illustrates an exemplary hard drive slider 300 in accordance with embodiments of the present invention. During the etching of first substrate 302, one or more additional trenches may be made between the sliders in the first substrate 302. The sliders 300 will then be made by bonding the second substrate 306 to the first substrate 302. The second substrate 306 will then be ground, lapped and polished down to a final thickness. Finally, the rest of the slider, including the air bearing system and the head, can be made using conventional processes. This slider design has the advantage of defining and ensuring the thickness of the flexures early on instead of by a later process. For example, in other embodiments when the air bearing system is being made the flexures 304 may be further etched and the thickness thus reduced. In another yet embodiment of the invention, the flexures may be further cut or etched to form four or more flexures.

FIG. 3E further illustrates an exemplary drive slider 300 in accordance with embodiments of the present invention. After the slider 300 has been assembled in accordance with the embodiments described above, but before the flexures are formed, interconnections traces 312 can be formed along flexure 304 positions to connect the plurality of contacts 308 on the primary slider body 302 with the plurality of contacts 310 on the lighter secondary slider body 306. The interconnection traces 312 are formed on the opposite side of the slider 300 from the ABS. This side of the slider 300 opposite the ABS may be referred to as the flex side. The interconnection traces 312 do not mechanically interact with the movement of secondary slider body 306 or the flexures 304 relative to the primary slider body 302, as would be the case with conventional interconnection to the head, for example by soldering or wire boding.

The fabrication of the interconnection traces 312 can be done after the sliders or groups of sliders are separated and the flex side preparation, including lapping, is completed. For example, the sliders 300 can be assembled in a planar array, such that lithographic processing may be performed which is similar to the preparation processes used to create the ABS. The sliders 300 are then etched in the secondary slider body 306 to expose a plurality of metallic contacts 310 of each of the desired circuits in the head. These circuits can include, the read control, writer control and fly height control. The procedure to expose the plurality of built in contacts 308 on the primary slider body 302 of the slider 300 can be a Reactive Ion Etch (RIE) through an insulator which is a few microns thick. Then an insulator can be deposited upon the flexures 304 and portions of the secondary slider body 306 and portions of primary slider body 302 to allow deposition of the interconnection traces 312. A blanket plating seedlayer can then be deposited along with a photoresist layer then patterned to allow the electroplating of interconnection traces 312 to the contacts of the exposed head 310 and primary slider body contacts 308. After the electroplating, the photoresist and seedlayer are removed and head contacts 310 are now connected via interconnection traces 312 along the flexures 304 to primary slider body contacts 308 on the primary slider body 302. The resistance of the interconnection traces 312 is relatively small. For example, the resistances of gold interconnection traces 312 would be less than an Ohm when the interconnection traces 312 are 3 microns thick by 8 microns wide and 300 microns long along the flexures 304. In another embodiment of the invention, a further insulator and conductor layer could be included to act as a ground plane to improve electrical transmission characteristics. In another embodiment of the invention, a non-functional set of pads 309 can be put on the primary slider. These and the functional pads 308 can serve to make solder joints to the suspension. This would provide improved mechanical connection to the suspension and could avoid the need for a glue joint between the slider and the suspension.

In yet another embodiment, a portion of interconnection traces 312 can be coupled to heaters (not shown) which are coupled to flexures 304. The heaters may be external to flexures 304 or may be partially inside of flexures 304 or may be the flexures themselves.

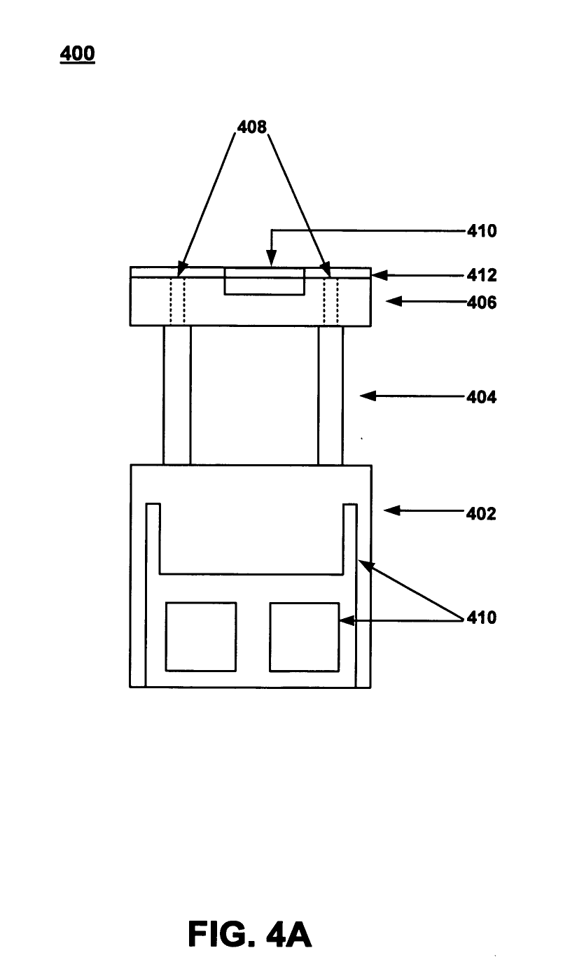

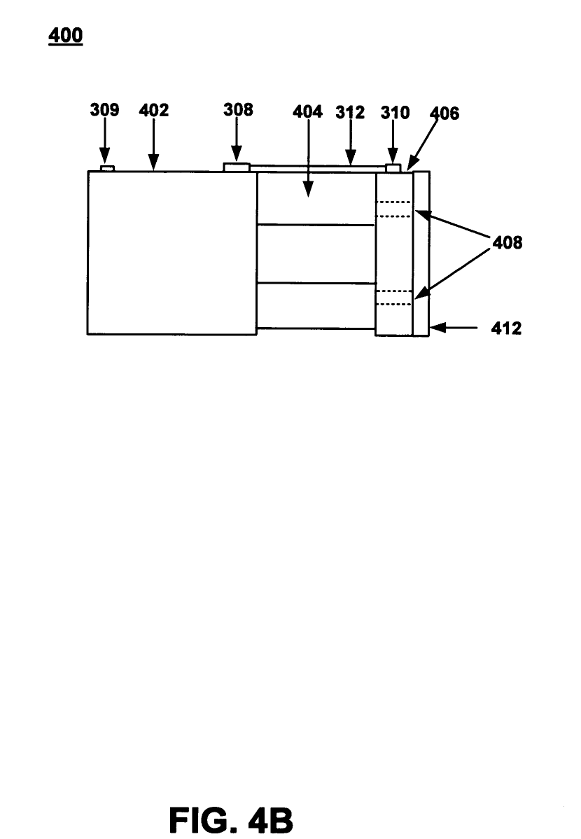

FIG. 4 is an illustration of an exemplary hard drive slider 400 in accordance with embodiments of the present invention. FIG. 4A illustrates a bottom view of an exemplary hard drive slider comprising a first substrate 402, a second substrate 404, a third substrate 406, a head 412, vias 408 and air bearing 410. In one embodiment of the invention, the hard drive slider may be used in a data recording disk drive.

In one embodiment of the invention, the first substrate 402 includes a substrate having a high conductivity, second substrate 404 comprises a substrate having a low conductivity or increased relative resistance and third substrate 406 comprises a substrate having a medium conductivity. This increased resistance in second substrate 404 may be accomplished by doping the second substrate 404 less than the first and third substrate. For example, first substrate 402 may have a resistivity of 0.001-0.01 ohm-cm while Second substrate 404 and third substrate 406 may have a resistivity of 0.1-1 ohm-cm. In one embodiment, a portion of all of the substrates may be made from silicon.

In one embodiment of the invention, second substrate 404 comprises a plurality of flexures. A plurality of flexures may be formed by using Deep Reactive Ion Etch (herein DRIE). For example, there may be four flexures etched using DRIE. The base for the flexures is the pits made in the second substrate 404 after it is coupled to the first substrate 402. The etching completes the forming of the flexures after coupling the third substrate 406 to second substrate 404 by removing two walls and portions of the remaining walls. In another embodiment of the invention, the flexures may be defined during the process used to generate the air bearing. For example, the flexures may be 50×45 microns cross-sectionally for a femto slider cross-section. The flexures can have a length of approximately 300 microns with an approximate heating length of 250 microns. The length of the flexures may be based on the length necessary to move the head 412. In another embodiment of the invention, second substrate 404 is etched to remove a portion of second substrate 404 from proximity to a disk.

The result of this lower level of doping or increased resistance in second substrate 404 causes higher joule heating and therefore expansion as current flows through the flexures. For example, boron may be used to dope the various substrates. In one embodiment of the invention, the current will cause an increase in temperature due to increased resistance resulting in at least one of the flexures expanding. In another embodiment of the invention, the flexures may be heated via a separate device coupled to the flexures. This expansion or contraction of second substrate 404 may allow the invention to be used in contact, contact on demand and non-contact recording devices. In one embodiment of the invention, the near contact recording may be in the 1-3 nm regimes.

In another embodiment of the invention, the slider may be formed with only two substrates. The first substrate 302 will be etched to form pits or trenches which will later become flexures 304. The first substrate 302 and second substrate 306 will be made of the same material and the heating of the flexures 304 will be controlled only by the cross section of the material. The current density will be much higher in the flexures 304 than the thick material of the rest of the slider. This allows the flexures to expand relative to the rest of the slider 300 and thus allow dynamic control of the position of the hard drive head.

In one embodiment of the invention, the current may be provided to second substrate 404 though vias 408 in third substrate 406. Vias in the third substrate 406 may be provided to allow current to any and all of the flexures formed by second substrate 404. Thus, the current may dynamically control the position of the head 412 in all three dimensions as the plurality of flexures expand and/or contract.

In another embodiment of the invention, vias may be formed by etching partially through third substrate and then filling the vias with electroplating to provide ohmic contacts to the flexures formed by second substrate 404 and the connections to the pads on the slider which will drive them. For example, the partial etching of the third substrate may be done with DRIE and be approximately 10-20 microns in diameter.

In one embodiment of the invention, third substrate 406 is coupled to second substrate 404. Third substrate 406 may be ground, lapped and polished and then head 412 may be built on top using conventional methods. The third substrate 406 may have a thickness that makes it sufficiently thin to keep the mass of the slider low and to keep the area which is pressed against the disk or very close to the disk from exerting too large a force to move the whole system. As a result the flexures are flexible to allow dampening of vibrations but also sufficiently rigid to allow control of positioning the head. For example, the third substrate may have an approximate thickness of 25-75 microns. At least one of the flexures formed by second substrate 404 may respond to a current by moving head 412 with respect to slider 400.

In another embodiment of the invention, the expansion or contraction of the flexures formed by second substrate 404 may be used to perform tilt adjustment on the trailing edge in order to compensate skew of the head 412 as it moves from inner disk to outer disk (herein ID and OD respectively).

In one embodiment of the invention, the slider is used for Thermal Fly Height Control (herein TFC). A first fly height of head 412 is determined by measuring the height of head 412 above the disk. Then the first fly height may be compared to a second fly height which may be a desired fly height for reading or writing data to a disk or dampening vibrations. Then a current may be applied to at least one of the flexures formed by second substrate 404 to achieve the second or desired fly height. In another embodiment of the invention, the control, measurement and adjustment of the fly height may be controlled by an electronics module of a hard disk drive. Although all lines are shown as linear, it is understood that they can also be curved or any other shape.

In one embodiment of the invention, the flexures formed by second substrate 404 are used to support interconnection traces between the larger primary body of the slider 400 and the lighter head part of the slider. The traces run from head contacts along the flexures formed by second substrate 404 to bond pads on the primary body of the slider 400 on the side opposite of the ABS 410. This side opposite the ABS 410 may be known as the flex side. This interconnection occurs between the bonds pads on the slider 400 and the bond pads on the suspension and does not mechanically interact with the head 412 or the flexures formed by second substrate 404.

The fabrication of the traces is after the sliders or groups of sliders are separated and the flex side preparation, including lapping, is completed. For example, the sliders 400 can be assembled in a planar array, such that lithographic processing may be performed which is similar to the preparation processes used to create the ABS. The sliders 400 are then etched in the secondary slider body 406 to expose metallic contact of each of the desired circuits in the head. These circuits can include, the read control, writer control and fly height control. The procedure to expose the built in contacts on the primary body 402 of the slider 400 can be a Reactive Ion Etch (RIE) through an insulator which is a few microns thick. Then an insulator would be deposited upon the flexures and the portions of the primary and secondary slider bodies to allow deposition of the interconnection traces. A blanket plating seedlayer would be deposited along with a photoresist layer then patterned to allow the electroplating of the traces to the contacts of the exposed head and bond pads. After the electroplating, the photoresist and seedlayer are removed and the head is now connected along the flexures to bond pads on the primary slider body 402. The resistance of the traces would be relatively small. For example, the resistances of gold traces would be less than an Ohm when the trace is 3 microns thick by 8 microns wide and 300 microns long along the flexures. In another embodiment of the invention, a further insulator and conductor layer could be included to act as a ground plane to improve electrical transmission characteristics.

FIG. 4B illustrates a side view of an exemplary hard drive slider includes a first substrate 402, a second substrate 404, a third substrate 406, a head 412 and vias 408. The exemplary hard drive slider further includes interconnection traces 312 which are deposited along flexures formed by second substrate 404. The interconnection traces 312 couple contacts 310 on secondary body of the slider formed by third substrate 406 with functional pads 308 on the primary slider body formed by first substrate 402. In one embodiment of the invention, a non-functional set of pads 309 can be put on the primary slider body formed by first substrate 402. These and the functional pads 308 can serve to make solder joints to the suspension. This would provide improved mechanical connection to the suspension and could avoid the need for a glue joint between the slider and the suspension. In another embodiment, a portion of the interconnection traces 312 may be coupled to heaters coupled to the flexures formed by second substrate 404. These heaters may be external or partially inside of flexures formed by second substrate 404 or may be the flexures themselves.

With reference to FIGS. 4A and 4B it can be seen that in one embodiment of the invention, there can be four flexures formed from second substrate 404.

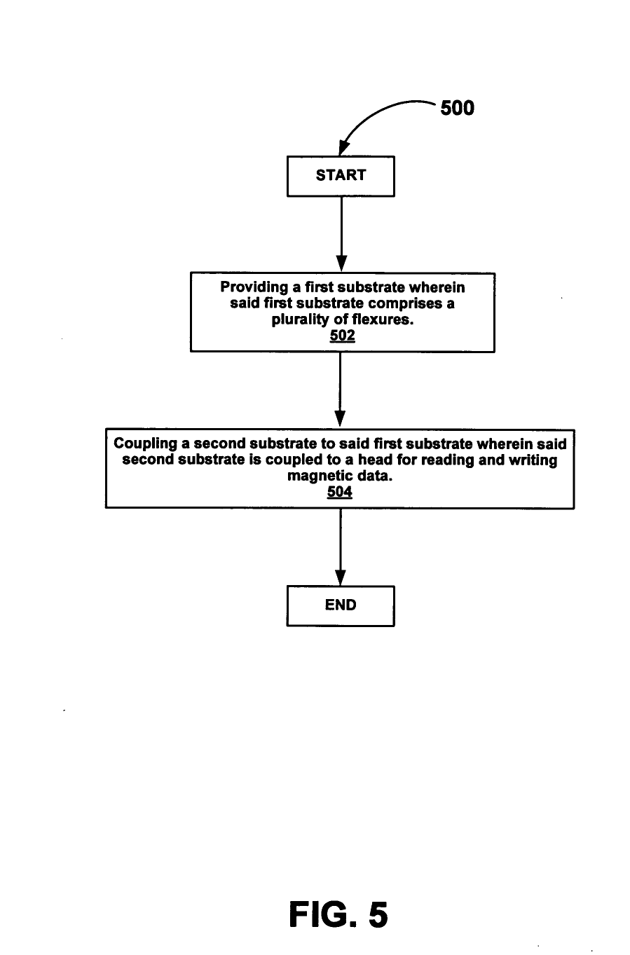

FIG. 5 is a flowchart of an exemplary method 500 for forming a hard drive slider 300 in accordance with one embodiment of the present invention. With reference to step 502 of FIG. 5 and to FIG. 3A, one embodiment provides a first substrate 302 forming the primary body of the hard drive slider. A portion of first substrate 302 will be etched or cut to create pits or trenches which later become flexures 304.

With reference now to step 504 of FIG. 5 and to FIG. 3A, one embodiment provides a second substrate 306 which is coupled to first substrate 302. The second substrate 306 is then ground, lapped, polished to a final thickness. In one embodiment of the invention, the hard drive head or transducer is formed on second substrate 306 using conventional processes. A portion of the Air Bearing System (ABS) can be formed on the first substrate 302 and second substrate 306 using conventional processes. The pits or trenches of the first substrate 302 form a set of horizontal and parallel flexures 304 in the final slider. These flexures 304 may be designed to allow movement in the vertical direction, with restricted movement in the lateral direction. This flexibility in the slider 300 may be known as compliance.

The flexibility further reduces the friction should there be contact with the disk because the flexures 304 will deform as the secondary slider body formed by second substrate 306 of the slider 300 pushes against the air bearing. The fact that movement is mainly in the vertical direction means that the frictional forces can not couple and thereby excite the first natural mode of the compliant slider. Slider 300 is constructed such that the trailing edge of slider 300 will have resonance modes only at high frequencies beyond the ABS modes and are not likely to be excited by asperities in the disk or operational shocks. Thus, the slider can respond to shock events in much better manner than conventional sliders which would have a rigid impact with the disk.

The flexures 304 also reduce the mass and therefore the inertia of the secondary slider. The reduced inertia reduces the severity of impacts cause by shock events and asperities in the disk. The trailing edge has an ABS such that the relatively smaller mass of the trailing edge can respond easier to any asperities or operational shocks that occur as the air bearing pushes against the secondary slider body formed by second substrate 306.

In one embodiment of the invention, the slider will have a pitch or position such that the primary slider body formed by first substrate 302 will fly stably higher above the disk than the trailing edge formed by substrate 306 and contains the head which is connected to the primary slider body by flexures 304. This flying configuration ensures in the primary slider body encounters only large asperities in the disk and requiring the slider 300 to travel farther to come in contact with the disk when there is an operational shock.

In one embodiment the flexures 304 will have the same thickness and be symmetrical. The thickness of the flexures 304 and other dimensions of the slider will largely be chosen based on the material used. For example, in one embodiment of the invention silicon is used as a base for the substrates.

With further reference to FIG. 5 step 504 and to FIGS. 3B one embodiment further provides removing a portion of the sides of the end of slider 300 where the head is located. With reference to FIG. 3B, the removal may be such that the portions removed form perpendicular edges with the primary slider body. The forming of the flexures connected to the secondary part of the slider which contains the head is done during the etching of the first substrate 302. In yet another embodiment, portions of the primary body of the slider may also be etched away in a step after the processes used to form the air bearing. These removals of portions of the slider 300 reduce the effective mass of the secondary part of the slider and further ensure that the head and sides of the slider will not impact the disk in the case of a roll of the slider laterally.

With further reference now to FIG. 5 step 502 and to FIG. 3D, one embodiment provides etching of first substrate 302, with one or more trenches between the sliders in the first substrate 302. The sliders 300 will then be made by bonding the second substrate 306 to first substrate 302. The second substrate 306 will then be ground, lapped and polished down to a final thickness. Finally, the rest of the slider, including the air bearing system and the head, can be made using conventional processes. This additional etching has the advantage of defining and ensuring the thickness of the flexures early on. For example, often when the air bearing system is being made the flexures 304 may be further etched and the thickness reduced.

With reference now to FIG. 5 step 504 and to FIG. 3E, one embodiment further provides connecting the plurality of contacts 308 on primary slider body 302 to the plurality of contacts 310 on the secondary slider body 306 of slider 300 via interconnection traces 312. The interconnection traces 312 are formed such that they do not mechanically interfere with the movement of secondary slider body 306 and the deformation of slider 300 via flexures 304. The interconnection traces 312 are formed on the side of the slider 300 opposite the ABS. This side opposite the ABS may be known as the flex side.

The fabrication of interconnection traces 312 may be after the sliders or groups of sliders are separated and the flex side preparation, including lapping, is completed. For example, the sliders 300 can be assembled in a planar array, such that lithographic processing may be performed which is similar to the preparation processes used to create the ABS. The sliders 300 are then etched in the secondary slider body 306 to expose the plurality of metallic contacts 310 of each of the desired circuits in the secondary slider body 306. These circuits may include, the read control, writer control and fly height control. The procedure to expose the plurality of built in contacts 308 on the primary slider body 302 of the slider 300 can be a Reactive Ion Etch (RIE) through an insulator which is a few microns thick. Then an insulator will be deposited upon the flexures 304 and the portions of the secondary slider body 306 and primary slider body 302 to allow deposition of the interconnection traces 312. A blanket plating seedlayer would be deposited along with a photoresist layer then patterned to allow the electroplating of the interconnection traces 312 to the contacts of the exposed head of secondary slider body 306 and primary slider body 302. After the electroplating, the photoresist and seedlayer are removed and the head is now connected via flexures 304 to contacts 308 on the primary slider body 302. The resistance of the interconnection traces 312 will be relatively small. For example, the resistances of the interconnection traces 312 will be less than an Ohm when the trace is 3 microns thick by 8 microns wide and 300 microns long along the flexures 304. In another embodiment of the invention, a further insulator and conductor layer could be included to act as a ground plane to improve electrical transmission characteristics.

In another yet embodiment of the invention, the slider may be formed using the processes presented previously with a final step of cutting or etching the flexures 304 in the vertical direction thereby forming four or more flexures.

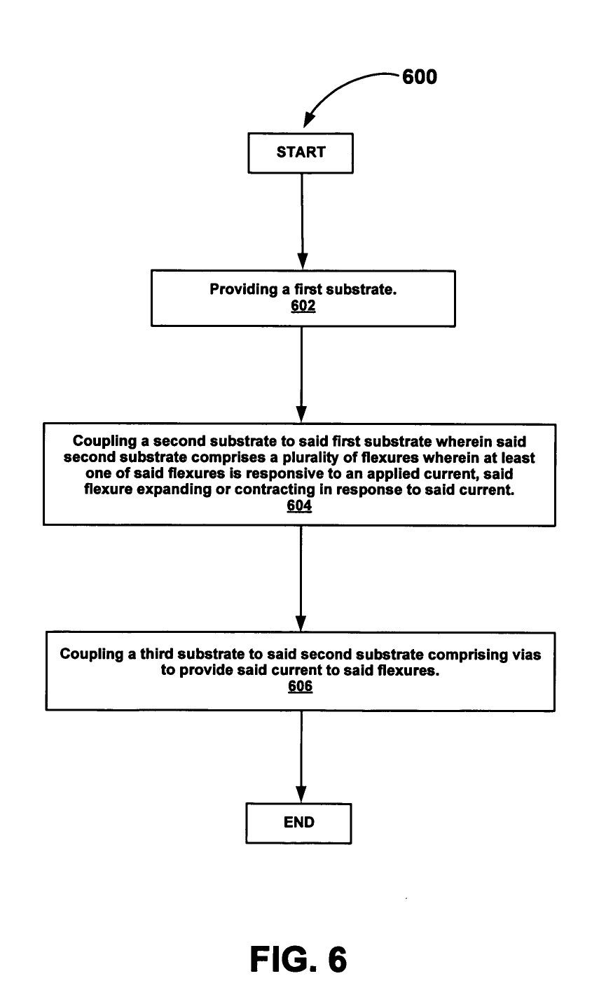

FIG. 6 is a flowchart of an exemplary method 600 for forming a hard drive slider 400 in accordance with one embodiment of the present invention. With reference to step 602 of FIG. 6 and to FIG. 4, one embodiment provides a first substrate 402 forming the primary body of the hard drive slider.

With reference now to step 604 of FIG. 6 and to FIG. 4, one embodiment provides a second substrate 404 which is coupled to first substrate 402. Substrate 402 may be etched a plurality of times to form flexures. For example, the flexures may be formed from the second substrate 404 by using DRIE. This etching may be done in two steps 1) etching the second substrate 404 to form walls on the edges after coupling it to first substrate 402 and 2) completing the forming of the flexures after coupling the third substrate 406 to second substrate 404 by removing two walls and portions of the remaining walls. In another embodiment of the invention, the flexures may be defined during the process used to generate the air bearing. Air Bearing 410 may be formed on first and third substrate as well as head 412. For example, the flexures may be 50×35 microns cross-sectionally for a femto slider cross-section. The flexures can have a length of approximately 300 microns with an approximate heating length of 250 microns. The length of the flexures may be based on the length necessary to move the head 412 or the desired compliance.

In another embodiment of the invention, the method may provide etching a portion of the flexures formed by second substrate 404 to remove a portion of the flexures formed by second substrate 404 in order to remove the flexures from proximity to the disk.

In one embodiment of the invention, the method may provide that a portion of second substrate 404 may be doped with a material to a lesser degree to reduce the conductivity and thus increase the resistive heating in response to a current causing expanding or contracting at least one of the flexures formed by second substrate 404. For example, second substrate 404 may be doped with boron. This expansion or contraction of at least one of the flexures formed by substrate 404 causes a moving of head 412. This expansion or contraction also allows dynamically adjusting the length of at least one of the flexures formed by second substrate 404. In another embodiment of the invention, the flexures may be heated via an external source.

In another embodiment of the invention, the method may provide determining a first fly height for head 412 and then comparing it to a second fly height which may be a desired fly height. A current may then be determined corresponding to the difference between the first fly height and the second height. Then the determined current may be applied to the flexures formed by second substrate 404 in order to achieve the second fly height.

With reference now to Step 606 of FIG. 6 and to FIG. 4, one embodiment of the invention provides a third substrate 406. Third substrate 406 is coupled to the second substrate 404. In one embodiment of the invention, the hard drive transducer or head is mounted on third substrate 406. Third substrate 406 further comprises vias for providing current to the flexures formed by second substrate 404. In another embodiment of the invention, vias may be formed by etching partially through third substrate and then filling the vias with electroplating to provide ohmic contacts to the flexures formed by second substrate 404 and the connections to the pads on the slider which will drive them. For example, the partially etching of the third substrate may be done with DRIE and be approximately 10-20 microns in diameter.

With reference now to FIG. 6 step 606 and to FIG. 3E, one embodiment provides connecting the plurality of contacts 308 on primary slider body 302 to the plurality of contacts 310 on the secondary slider body 306 of slider 300 via interconnection traces 312. The interconnection traces 312 are formed such that they do not mechanically interfere with the movement of secondary slider body 306 and the deformation of flexures 304 relative to primary slider body 302. The interconnection traces 312 are formed on the side of the slider 300 opposite the ABS. This side may be known as the flex side.

The fabrication of interconnection traces 312 is after the slider rows are separated and the flex side preparation, including lapping, is completed. For example, the sliders 300 can be assembled in a planar array, such that lithographic processing may be performed which is similar to the preparation processes used to create the ABS. The sliders 300 are then etched in the secondary slider body 306 to expose the plurality of metallic contacts 310 of each of the desired circuits in the secondary slider body 306. These circuits can include, the read control, writer control and fly height control. The procedure to expose the plurality of built in contacts 308 on the primary slider body 302 of the slider 300 can be a Reactive Ion Etch (RIE) through an insulator which is a few microns thick. Then an insulator will be deposited upon the flexures 304 and portions of secondary slider body 306 and primary slider body 302 to allow deposition of the interconnection traces 312. A blanket plating seedlayer would be deposited along with a photoresist layer then patterned to allow the electroplating of the interconnection traces 312 to the contacts of the secondary slider body 306 and primary slider body 302. After the electroplating, the photoresist and seedlayer are removed and the head is now connected along the flexures 304 to contacts 308 on the primary slider body 302. The resistance of the interconnection traces 312 will be relatively small. For example, the resistances of gold interconnection traces 312 will be less than an Ohm when the trace is 3 microns thick by 8 microns wide and 300 microns long along the flexures 304. In another embodiment of the invention, a further insulator and conductor layer could be included to act as a ground plane to improve electrical transmission characteristics.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and it's practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A hard drive slider comprising:
a first substrate wherein said first substrate comprises a plurality of flexures;
a second substrate coupled to said first substrate wherein said second substrate is coupled to a head for reading and writing magnetic data.

2. A hard drive slider as recited in claim 1 wherein said flexures respond to a current by expanding or contracting.

3. A hard drive slider as recited in claim 1 wherein the thickness of said flexures is defined during the etching of the first substrate.

4. A hard drive slider as recited in claim 1 wherein traces along said flexures electrically coupled said head with said first substrate.

5. A hard drive slider as recited in claim 4 wherein a portion of said traces are coupled to a plurality of heaters coupled to said flexures.

6. A hard drive slider as recited in claim 1 wherein said hard drive slider responds to shock by allowing the head to move relative to the slider body.

7. A hard drive slider as recited in claim 1 wherein said upper and lower flexures have the same thickness.

8. A hard drive slider as recited in claim 1 wherein said second substrate has a reduced area relative to the slider body.

9. A hard drive slider as recited in claim 1 wherein a plurality of pads are coupled to said slider for coupling said slider to a suspension.

10. A method for forming a hard drive slider comprising:
providing a first substrate wherein said first substrate comprises a plurality of flexures; and
coupling a second substrate to said first substrate wherein said second substrate is coupled to a head for reading and writing magnetic data.

11. The method of claim 10 wherein said first substrate comprises a material such that said flexures respond to a current by expanding.

12. The method of claim 10 further comprising:
defining the thickness of the flexures during the etching of said first substrate.

13. The method of claim 10 further comprising:
depositing electrical traces along said flexures wherein said traces communicatively couple said head to said first substrate.

14. The method of claim 13 further comprising:
coupling a portion of said electrical traces to a plurality of heaters coupled to said flexures.

15. The method of claim 10 further comprising:
forming said hard drive slider so that it responds to shock by allowing the head to move relative to the slider body.

16. The method of claim 10 further comprising:
forming said flexures such that said flexures have the same thickness on said upper and lower flexures.

17. The method of claim 10 further comprising:
forming said flexures and said second substrate wherein said second substrate has a reduced area relative to the slider body.

18. The method of claim 10 further comprising:
coupling a plurality of pads to said slider for coupling said slider with a suspension.

19. A data recording disk drive comprising:
a plurality of disks with data surfaces of concentric data tracks;
a rotator for rotating said disks about an axis generally perpendicular to said disks;
a transducer attached to a slider for reading data from and writing data to said data surface;
an actuator for moving said slider generally radially to the disk to allow said transducer to access said data tracks;
an electronics module for processing data read from and written to the data surface; and
said slider maintained in operative relationship with the data surface when the disk is rotating, comprising:
a first substrate wherein said first substrate comprises a plurality of flexures;
a second substrate coupled to said first substrate wherein said second substrate is coupled to a head for reading and writing magnetic data.

20. A hard drive slider as recited in claim 19 wherein said flexures respond to a current by expanding or contracting.

21. A hard drive slider as recited in claim 19 wherein the thickness of said flexures is defined during the etching of the first substrate.

22. A hard drive slider as recited in claim 19 wherein said hard drive slider responds to shock by allowing the head to move vertically.

23. A hard drive slider as recited in claim 19 wherein said upper and lower flexures have equivalent thickness.

24. A hard drive slider as recited in claim 19 wherein said second substrate has a reduced area relative to the slider body.

25. A hard drive slider as recited in claim 19 wherein a plurality of pads are coupled to said slider for coupling said slider to a suspension.

26. A hard drive slider as recited in claim 19 wherein electrical traces are deposited along said flexures communicatively couple said head with the rest of said hard drive slider.

27. A hard drive slider as recited in claim 26 wherein a portion of said electrical traces are coupled to a plurality of heaters coupled to said flexures.

28. A hard drive slider comprising:
a first substrate;
a second substrate coupled to said first substrate wherein said second substrate comprises a plurality of flexures wherein at least one of said flexures is responsive to an applied current, said flexure expanding or contracting in response to said current; and
a third substrate coupled to said second substrate comprising vias to provide said current to said flexure.

29. A hard drive slider as recited in claim 28 wherein a portion of said second substrate is doped with a material that responds to said current causing said expanding.

30. A hard drive slider as recited in claim 28 wherein said current dynamically controls the position of said head.

31. A hard drive slider as recited in claim 28 wherein a portion of said second substrate is etched to remove a portion of said second substrate from proximity to a disk.

32. A hard drive slider as recited in claim 28 wherein at least one of said flexures dampen vibrations by said expanding in response to said current.

33. A hard drive slider as recited in claim 28 wherein at least one of said flexures respond to said current by moving said head with respect to said slider.

34. A hard drive slider as recited in claim 28 wherein a plurality of pads are coupled to said slider for coupling said slider to a suspension.

35. A hard drive slider as recited in claim 28 wherein conductive traces are used to communicatively couple the body of said hard drive slider with a head.

36. A hard drive slider as recited in claim 35 wherein a portion of said conductive traces are coupled to a plurality of heaters coupled to said flexures.

37. A data recording disk drive of claim 28 wherein said slider further comprises pads for mechanically coupling said slider to said suspension.

38. A method for forming a hard drive slider comprising:
providing a first substrate;
coupling a second substrate to said first substrate wherein said second substrate comprises a plurality of flexures wherein at least one of said flexures is responsive to an applied current, said flexure expanding or contracting in response to said current; and
coupling a third substrate to said second substrate comprising vias to provide said current to said flexures.

39. The method of claim 38 further comprising:
doping a portion of said second substrate with a material that increases joule heating in response to said current causing said expanding.

40. The method of claim 38 further comprising:
dynamically adjusting the length of at least one of said flexures by providing a current.

41. The method of claim 38 further comprising:
etching a portion of said second substrate to remove a portion of said second substrate from proximity to the disk.

42. The method of claim 38 further comprising:
determining a first fly height and comparing said first fly height to a second fly height.

43. The method of claim 42 further comprising:
determining a current corresponding to a difference between said first fly height and said second fly height; and
applying said current.

44. The method of claim 38 wherein said slider further comprises pads for mechanically coupling said slider to said suspension.

45. The method of claim 44 further comprising:
coupling said slider with a suspension via said plurality of bond pads coupled to said slider.

46. The method of claim 38 further comprising:
communicatively coupling said first substrate with said third substrate via traces on said flexures.

47. The method of claim 46 further comprising:
coupling a portion of said traces to a plurality of heaters coupled to said flexures.

48. A data recording disk drive comprising:
a plurality of disks with data surfaces of concentric data tracks;
a rotator for rotating said disks about an axis generally perpendicular to said disks;
a transducer attached to a slider for reading data from and writing data to said data surface;
an actuator for moving said slider generally radially to the disk to allow said transducer to access said data tracks;
an electronics module for processing data read from and written to the data surface; and
said slider maintained in operative relationship with the data surface when the disk is rotating, comprising:
a first substrate;
a second substrate coupled to said first substrate wherein said second substrate comprises a plurality of flexures wherein at least one of said flexures is responsive to an applied current, at least one of said flexure expanding or contracting in response to said current; and
a third substrate coupled to said second substrate comprising vias to provide said current to said flexure.

49. A data recording disk drive of claim 48 wherein a portion of said second substrate is doped with a material that responds to said current causing said expanding.

50. A data recording disk drive of claim 48 wherein a portion of said second substrate is etched to remove a portion of said second substrate from proximity to a disk.

51. A data recording disk drive of claim 48 wherein said transducer is moved by applying a current to at least one of said flexures.

52. A data recording disk drive of claim 48 wherein at least one of said flexures respond to said current by moving said head with respect to said slider.

53. A data recording disk drive of claim 48 wherein said electronics module dynamically controls the position of said transducer by applying a current to at least one of said flexures.

54. A data recording disk drive of claim 48 wherein said slider further comprises pads for mechanically coupling said slider to said suspension.

55. A data recording disk drive of claim 48 wherein conductive traces on said flexures communicatively couple said electronics module with said transducer.

56. A data recording disk drive of claim 55 wherein a portion of said conductive traces on said flexures are coupled to a plurality of heaters coupled to said flexures.
